(19) United States
(12) Patent Application Publication
(10) Pub. No.: US 2011/0024075 A1
(43) Pub. Date: Feb. 3, 2011

(54) SYSTEM AND METHOD FOR REGENERATING HEAT ENERGY

(75) Inventor: Bengt Östlund, Sollentuna (SE)

Correspondence Address: DRINKER BIDDLE & REATH (DC), 1500 K STREET, N.W., SUITE 1100, WASHINGTON, DC, 20005-1209, US

(73) Assignee: EXENCOTECH AB

(21) Appl. No.: 12/934,574

(22) PCT Filed: Mar. 31, 2008
(86) PCT No.: PCT/SE08/50371

§ 371 Date: Sep. 24, 2010

(51) Int. Cl. F28D 19/00; F28D 15/04

(52) U.S. Cl. 165/10; 165/104.26

(57) ABSTRACT

The present invention relates to a method for regenerating heat energy with the aid of an energy system comprising n number of energy cells (12₁, . . . ,12ₙ), wherein n is an integer, and n>2. The energy cells (12₁, . . . ,12ₙ) are connected in sequence. Each energy cell (12₁, . . . ,12ₙ) comprises a phase change material (PCM₁, . . . ,PCMₙ), wherein PCMT₁>PCMT₂>, . . . , >PCMTₙ. The energy cells (12₁, . . . ,12ₙ) performs the steps:
to produce mechanical energy, which also causes rest heat energy (RH₁, . . . ,RHₙ) stored in said energy cell (12₁, . . . ,12ₙ) when the phase change material (PCM₁, . . . ,PCMₙ) changes from solid phase to liquid phase; or
to cool down when the phase change material (PCM₁, . . . ,PCMₙ) changes from liquid phase to solid phase;
to transfer said rest heat energy (RHₓ) from one energy cell (12ₓ) which is cooling down as input energy to the next energy cell (12ₓ₊₁), said method comprises the step:
with the aid of a control means connected to said energy cells (12₁, . . . ,12ₙ), to control said system alternately between a first phase, and a second phase, wherein, during said first phase, every two energy cells (12₁, 12₃, 12₅, . . . ) produces mechanical energy, and every two energy cells (12₂, 12₄, 12₆, . . . ) are cooling down, and vice versa during said second phase.

### FIELD OF THE INVENTION

The present invention relates, in a first aspect, to an energy system operable to regenerate heat energy.

According to a second aspect, the present invention relates to a method for regenerating heat energy.

### BACKGROUND OF THE INVENTION

to The patent document DE 10 2005 039 270 A1 relates to a device and method for numerous converting of heat energy into mechanical energy, storing the mechanical energy and converting the stored energy to electrical energy. Expanded through applied heat, expanding bodies (EB) (12) are interconnected as desired in a cascade or in parallel. Lengthening produced through heat and shortening produced by cooling is made usable at the end of the EB in the form of energy. A device heats up the EB. Linked to EB output, a cylinder piston system reduces overall strokes. A mixing/heat exchanger device optimizes use of heat. An independent claim is also included for method for operating a system for producing energy by attaining thermal expansion and by converting thermal expansion into work.

The patent document U.S. Pat. No. 5, 685 289 relates to an improved heat storage device, particularly for use in a solar energy system. A two layer system for heat energy capture and storage with an upper or lower layer for heat extracting and the other layer for heat transfer. Either layer can function as a phase change material. Heat stored is conducted externally of the system and can be used directly in a converting system, i.e. heat to mechanical or electrical energy or transferred as heat for further applications.

The patent document U.S. Pat. No. 5, 638, 673 relates to a method and apparatus that uses hydrogen-occluded alloy for recovering power from waste heat, and more particularly to a method and apparatus for recovering power from waste heat that uses hydrogen gas and heat emitted from hydrogen-occluded alloy to drive a turbine to generate power. The apparatus includes first and second heat exchangers containing hydrogen-occluded alloy, a first selector valve for alternating introduction of waste heat fluid between the first and second heat exchangers, a second selector valve for alternating introduction of cooling fluid between the first and second heat exchangers, a turbine associated with the heat exchangers, and a power generator connected to the turbine. The hydrogen-occluded alloy in the first and second heat exchangers is in the form of a multiplicity of stages that release the hydrogen gas at different temperatures, with the hydrogen gas being produced at a prescribed pressure by contact with waste heat fluid.

The patent document U.S. Pat. No. 6, 298, 665 B1 relates to a power generating device employing hydrogen absorbing alloy and low heat and further comprising: two types of hydrogen absorbing alloys which are able to reversibly absorb and release hydrogen gas and which have different thermal equilibrium hydrogen pressure characteristics; said two types of hydrogen absorbing alloys loaded respectively in a first determined hydrogen absorbing alloy heat exchanger container (1) and a second determined hydrogen absorbing alloy heat exchanger container (2) which are connected veritably to each other; at least two sets of heat generating cycles which employ heat generated when hydrogen gas is moved between said first hydrogen absorbing alloy heat exchanger container (1) and second hydrogen absorbing alloy heat exchanger container (2) provided; a hydrogen compound of one of said hydrogen absorbing alloys at a low temperature side having a high equilibrium pressure at the same temperature is heated by at least one low quality heat sources having a temperature from 15° C. to 200° C. to release hydrogen; said released hydrogen absorbed by the other hydrogen absorbing alloy at a high temperature side having a lower equilibrium hydrogen pressure to generate heat having a temperature from 80° C. to 500° C., which is higher than the temperature of the low quality heat source; said heat is transmitted to generate heating medium vapour; and where power is generated by a gas turbine driven by pressure of said heating medium vapour.

A problem and a disadvantage with the solutions disclosed in the above mentioned documents in particular, and in many known energy systems, is that the efficiency of the energy systems is not sufficient, and a general aim is to increase the efficiency of the energy system.

### SUMMARY OF THE INVENTION

The above mentioned problems are solved with an energy system operable to regenerate heat energy according to claim 1. The energy system comprises n number of energy cells, wherein n is an integer, and n ≧2. The energy cells are connected in a sequence. The system also comprises a heat source connected to the first energy cell, and a cooler means connected to the last energy cell. Each energy cell comprises a phase change material (PCM₁, . . . ,PCMₙ) with an average phase change temperature (PCMT₁, . . . ,PCMTₙ), wherein PCMT₁>PCMT₂> . . . >PCMTₙ. Each energy cell either produces mechanical energy which also causes rest heat energy (RH₁, . . . ,RHₙ) stored in said energy cell when the phase change material (PCM₁, . . . ,PCMₙ) changes from solid phase to liquid phase, or is cooling down when the phase change material (PCM₁, . . . ,PCMₙ) changes from liquid phase to solid phase. The rest heat energy from one energy cell which is cooling down is transferred as input energy to the next energy cell. The system also comprises a control means connected to the energy cells, and operable to control the system alternately between a first phase, and a second phase. During the first phase, every two energy cells produces mechanical energy, and every two energy cells are cooling down, and vice versa during the second phase.

A main advantage with the energy system according to the present invention is that the system efficiency is enhanced in relation to the efficiency of known energy systems.

Another advantage is that the average output power of the system is higher in comparison to known energy systems.

A further advantage with the energy system according to the present invention is that the energy system is scaleable, i.e. it can be used both as very small system (<10 W) to very large system (>1MV).

A further advantage in this context is achieved if each energy cell comprises a chamber means comprising said phase change material (PCM₁, . . . , PCMₙ), and in that said system also comprises a heat transfer system connected to said heat source, and to said cooler means, and to each of said chamber means.

Furthermore, it is an advantage in this context if said phase change for each phase change material (PCM₁, . . . ,PCMₙ) occurs between two different temperatures (Tₐ₁ and T_{b1}, . . . , Tₐₙ and T_{bn}), wherein T_{b1}>Tₐ₁, and in that said average phase change temperature is defined as PCMT₁=(Tₐ₁+T_{b1})/2.

A further advantage in this context is achieved if Tₐ₁>Tₐ₂, Tb₁>T_{b2}, . . . , T_{bn-1}>T_{bn}.

Furthermore, it is an advantage in this context if said heat transfer system comprises n number of container means, wherein each container means is connected to a chamber means and in that said heat transfer means also comprises a first conduit means connected to said heat source, to the cooler means, and there in between to an upper part of each container means, and a second conduit means connected to said heat source, to the cooler means, and there in between to a lower part of each container means, and in that said heat transfer system is equipped with a heat transfer media.

A further advantage in this context is achieved if said heat transfer media is water, oil, heat pipes or other suitable media in liquid or gas phases.

Furthermore, it is an advantage in this context if said energy system also comprises at least one valve means and/or at least one pump means, operable in connection with said alteration between said first phase and said second phase.

The above mentioned problems are also solved with a method for regenerating heat energy according to claim 8. The method is performed with the aid of an energy system comprising n number of energy cells, wherein n is an integer, and n≧2. The energy cells are connected in a sequence. Each energy cell comprises a phase change material (PCM₁, . . . ,PCMₙ) with an average phase change temperature (PCMT₁, . . . ,PCMTₙ), wherein PCMT₁>PCMT₂>PCMTₙ. The energy cells perform the steps:

to produce mechanical energy, which also causes rest heat energy (RH₁, . . . ,RHₙ) stored in said energy cell 12₁, . . . ,12ₙ when the phase change material (PCM₁, . . . ,PCMₙ) changes from solid phase to liquid phase; or

to cool down when the phase change material (PCM₁, . . . ,PCMₙ) changes from liquid phase to solid phase;

to transfer said rest heat energy from one energy cell which is cooling down as input energy to the next energy cell.

The method comprises the step:

with the aid of a control means connected to said energy cells, to control said system alternately between a first phase, and a second phase, wherein, during said first phase, every two energy cells produces mechanical energy, and every two energy cells are cooling down, and vice versa during said second phase.

A main advantage with the method for regenerating heat energy according to the present invention is that the method efficiency is enhanced in relation to the efficiency of known methods.

Another advantage is that the average output power of the method is higher in comparison to known methods.

A further advantage in this context is achieved if said method also comprises the steps:

with the aid of a heat source connected to said first energy cell, to transfer heat energy to said first energy cell; or

with the aid of a cooler means connected to said last energy cell, to remove said rest heat energy from said last energy cell.

Furthermore, it is an advantage in this context if said method also comprises the step:

with the aid of a heat transfer system connected to said heat source, to said cooler means, and to each of said energy cells, to transfer heat energy between said heat source, said energy cells, and said cooler means.

A further advantage in this context is achieved if said method also comprises the step:

for each phase change material (PCM₁, . . . ,PCMₙ) to perform said phase change between two different temperatures (Tₐ₁ and T_{b1}, . . . , Tₐₙ and T_{bn}), wherein T_{b1}>Tₐ₁, and in said average phase change temperature is defined as PCMT₁=(Tₐ₁+T_{b1})/2.

Furthermore, it is an advantage in this context if said method also comprises the step:

to choose said temperatures in such a way that Tₐ₁>Tₐ₂, T_{b1}>T_{b2}, . . . , T_{bn-1}>T_{bn}.

It will be noted that the term “comprises/comprising” as used in this description is intended to denote the presence of a given characteristic, step or component, without excluding the presence of one or more other characteristic features, integers, steps, components or groups thereof.

Embodiments of the invention will now be described with a reference to the accompanying drawings, in which:

### BRIEF DESCRIPTION OF THE DRAWINGS

FIG. 1 is a schematic diagram of a first embodiment of an energy system operable to regenerate heat energy according to the present invention;

FIG. 2 is a more detailed diagram of the energy system disclosed in FIG. 1;

FIG. 3 is a schematic diagram of a second embodiment of an energy system according to the present invention;

FIG. 4 is a schematic diagram of a third embodiment of an energy system according to the present invention;

FIG. 5 is a schematic diagram of a fourth embodiment of an energy system according to the present invention;

FIG. 6 is a schematic diagram of a fifth embodiment of an energy system according to the present invention;

FIG. 7 is a schematic diagram of a sixth embodiment of an energy system according to the present invention; and

FIG. 8 is a flow chart of a method for regenerating heat energy according to the present invention.

### DETAILED DESCRIPTION OF PREFERRED EMBODIMENTS

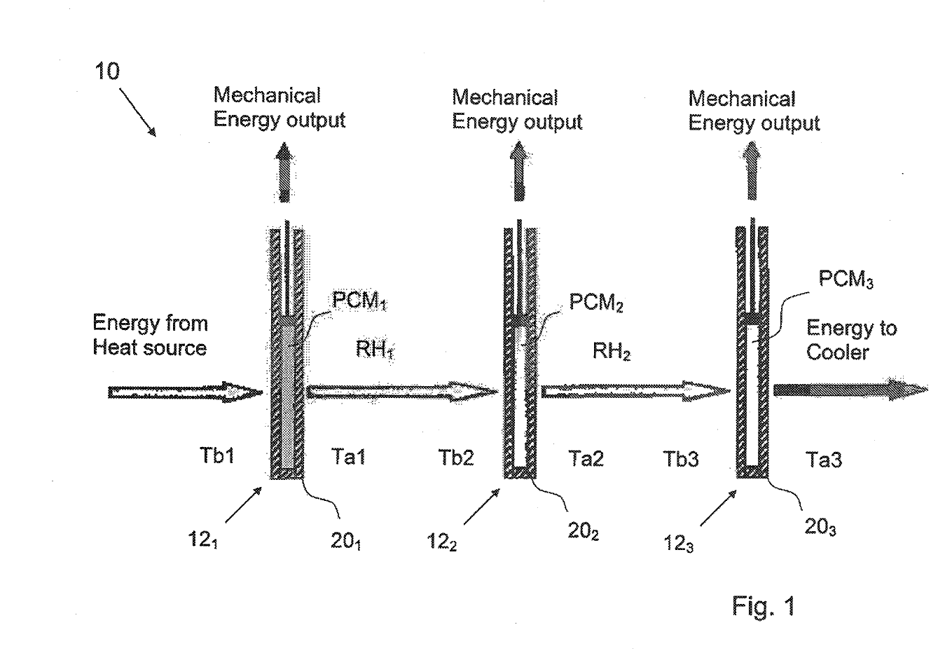

In FIG. 1 there is disclosed a schematic diagram of a first embodiment of an energy system 10 according to the present invention. The energy system 10 is operable to regenerate heat energy. In FIG. 1, the energy system 10 comprises three energy cells 12₁-12₃, which are connected in a sequence. Each energy cell 12₁;12₂;12₃ comprises a chamber means 20₁;20₂;20₃, which in turn comprises a phase change material PCM₁;PCM₂;PCM₃.

Each phase change material PCM₁;PCM₂;PCM₃ has an average phase change temperature PCMT₁;PCMT₂;PCMT₃, wherein PCMT₁>PCMT₂>PCMT₃. The average phase change temperature of the first phase change material PCM₁ is defined as PCMT₁=(Tₐ₁+T_{b1})/2, wherein the phase change occurs between the two temperatures Tₐ₁ and T_{b1}. The same applies for the other energy cells 12₂ and 12₃ with the corresponding phase change materials PCM₂ and PCM₃. Each energy cell 12₁;12₂;12₃ either produces mechanical energy, schematically disclosed in FIG. 1 with vertical arrows, and rest heat energy RH₁;RH₂;RH₃ stored in the energy cell 12₁;12₂;12₃ when the phase change material PCM₁;PCM₂;PCM₃ changes from solid phase to liquid phase. The rest heat energy, e.g. RH₁ from the first energy cell 12₁ which is cooling down is transferred as input energy to the second energy cell 12₂. The principle is that every two energy cells produces mechanical energy, and every two energy cells are cooling down. It is pointed out that T_{b1}>Tₐ₁, T_{b2}>Tₐ₂, and T_{b3}>Tₐ₃. This is possible, due to the fact that the temperature when the phase change appears is controlled by PCMs chemical formula. The freezing temperature for one PCM can be equal to a melting temperature of the next PCM. By doing this “waste heat energy” could be used again as “active heat energy”.

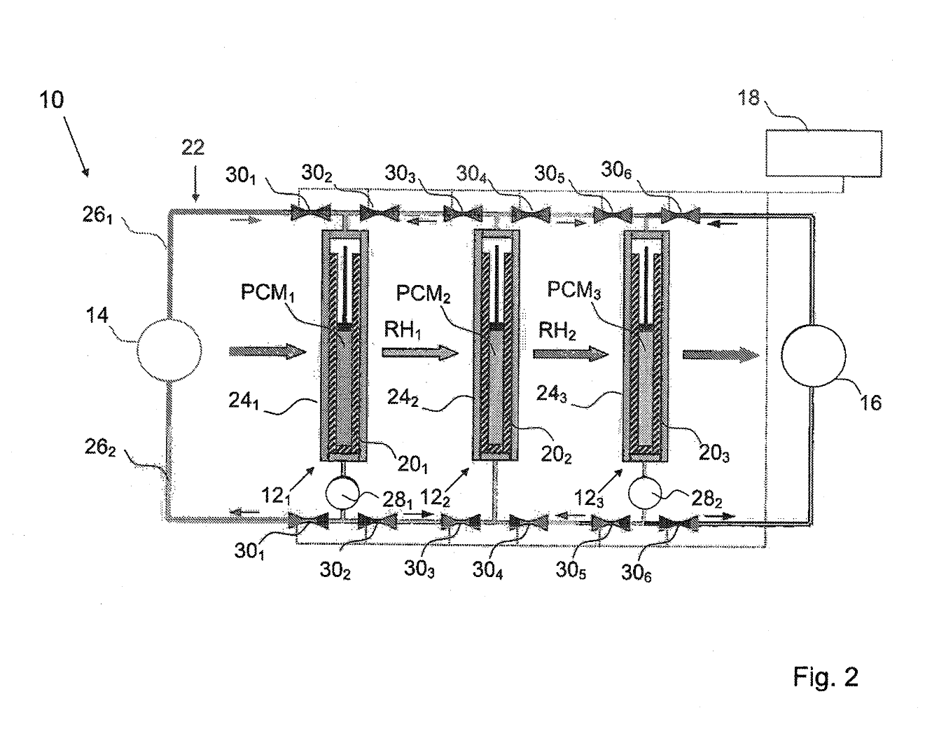

In FIG. 2 there is disclosed a more detailed diagram of the energy system 10 disclosed in FIG. 1. The same structural elements in FIGS. 1 and 2 have been denoted with the same reference signs, and will not in detail be described again. As is apparent in FIG. 2, the system 10 also comprises a control means 18 connected to the energy cells 12₁-12₃. The control means 18 is operable to control the system 10 alternately between a first phase, and a second phase. During the first phase, every two energy cells, e.g. 12₁ and 12₃, produces mechanical energy, and every two energy cells, in this particular case, 12₂ are cooling down. During the second phase, the energy cell 12₂ produces mechanical energy, and the energy cells 12₁ and 12₃ are cooling down. The energy system 10 disclosed in FIG. 2 also comprises a heat transfer system 22 connected to the heat source 14, the cooler means 16 and to each of the chamber means 20₁-20₃. As is apparent in FIG. 2, the heat transfer system 22 comprises a container means 24₁;24₂;24₃ for each chamber means 20₁;20₂;20₃. Furthermore, the heat transfer system 22 also comprises a first conduit means 26₁ connected to the heat source 14, the cooler means 16, and there in between to an upper part of each container means 24₁-24₃. The heat transfer system 22 also comprises a second conduit means 26₂ connected to the heat source 14, the cooler means 16, and there in between to a lower part of each container means 24₁-24₃. The heat transfer system 22 is equipped with a heat transfer media. Furthermore, in the embodiment disclosed in FIG. 2, the energy system 10 also comprises twelve valve means 30₁-30₆ arranged in the disclosed manner, and two pump means 28₁ and 28₂.

The heat transfer media can be water, oil, heat pipes, or other suitable media in liquid or gas phases.

Hereinafter follows a description of the function of the energy system 10 disclosed in FIG. 2. As described before, the function is divided in two different phases, a first phase, and a second phase.

During the first phase heat is transferred from the heat source 14 to the first chamber means 20₁, i.e. to the first energy cell 12₁, by the heat transfer system 22, which in the form of the first container means 24₁ surrounds the first chamber means 20₁. Both the valve means 30₁ are open and the pump means 28₁ is in operation. Simultaneously, heat is transferred from the second chamber means 20₂, i.e. the second energy cell 12₂, to the third chamber means 20₃, wherein the valve means 30₄, 30₅ are open and the pump means 28₂ is in operation. All other valve means, i.e. 30₂, 30₃ and 30₆ are closed. The first and third chamber means 20₁, 20₃, i.e. the first and third energy cells 12₁ and 12₃ produce mechanical energy by PCM volume expansion, while the second chamber means 12₂ is contracting, i.e. cooling down.

During the second phase, heat RH₁ is transferred from the first chamber means 20₁ to the second chamber means 20₂, wherein the valve means 30₂, 30₃ are open and the pump means 28₁ is in operation. Simultaneously, heat RH₃ is transferred from the third chamber means 20₃ to the cooler means 16, wherein the valve means 30₆ are open, and the pump means 28₂ is in operation. All other valve means are closed. The second chamber means 20₂, i.e. the second energy cell 12₂, produces mechanical energy by PCM volume expansion while the first and third chamber means 20₁ and 20₃, i.e. the first and third energy cells 12₁ and 12₃, are contracting, i.e. cooling down.

The control means 18 controls the energy system 10 in such a way that it's operation alter between the first phase and the second phase.

As described earlier, the heat transfer media can be water, and in that case the heat transfer system 22 can preferably be working at about 1 Bar, i.e. the normal atmospheric pressure, which simplify the design of the heat transfer system 22.

It is pointed out that energy cells of the same kind, i.e. with the same phase change material, PCM, can be connected in a group and simultaneously perform work. In accordance with the present invention, there can be n number of energy cells in a first group, or stage, which are working simultaneously, n number of energy cells in a second group, which are working simultaneously, and so forth.

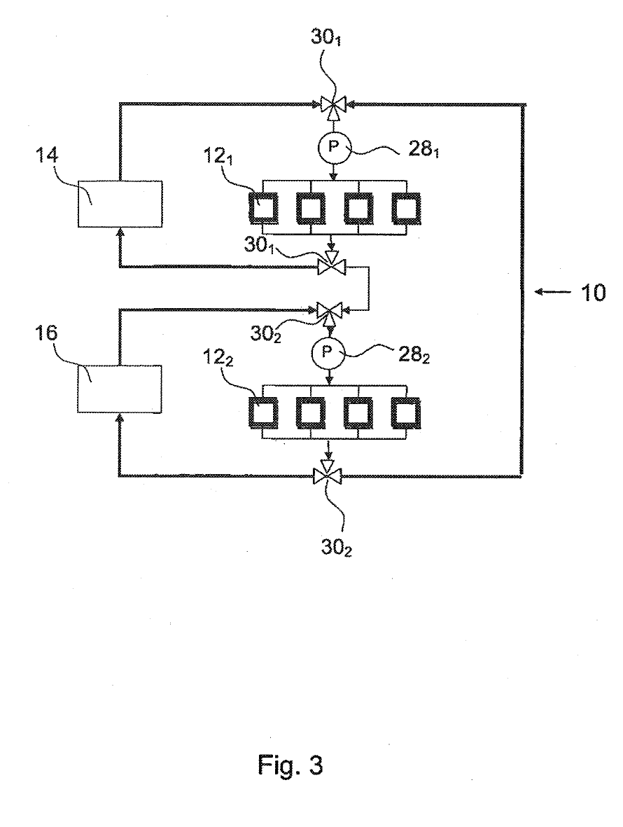

In FIG. 3 there is disclosed a schematic diagram of a second embodiment of an energy system 10 according to the present invention. In this embodiment there are two groups of energy cells, a first group with four energy cells 12₁, and a second group with four energy cells 12₂. In this embodiment, there are two pump means 28₁ and 28₂, and four valve means 30₁, 30₂.

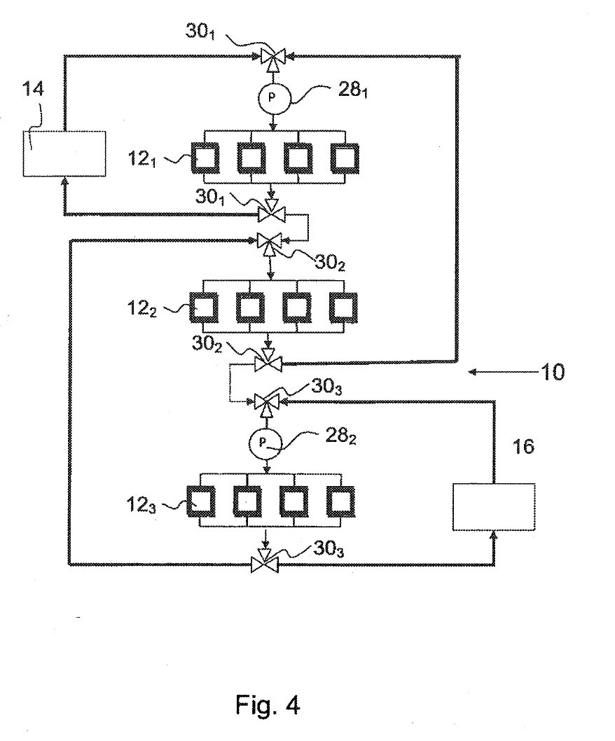

In FIG. 4 there is disclosed a schematic diagram of a third embodiment of an energy system 10 according to the present invention. In this embodiment there are three groups of energy cells, a first group with four energy cells 12₁, a second group with four energy cells 12₂, and a third group with four energy cells 12₃. In this embodiment, there are two pump means 28₁ and 28₂, and six valve means 30₁-30₃.

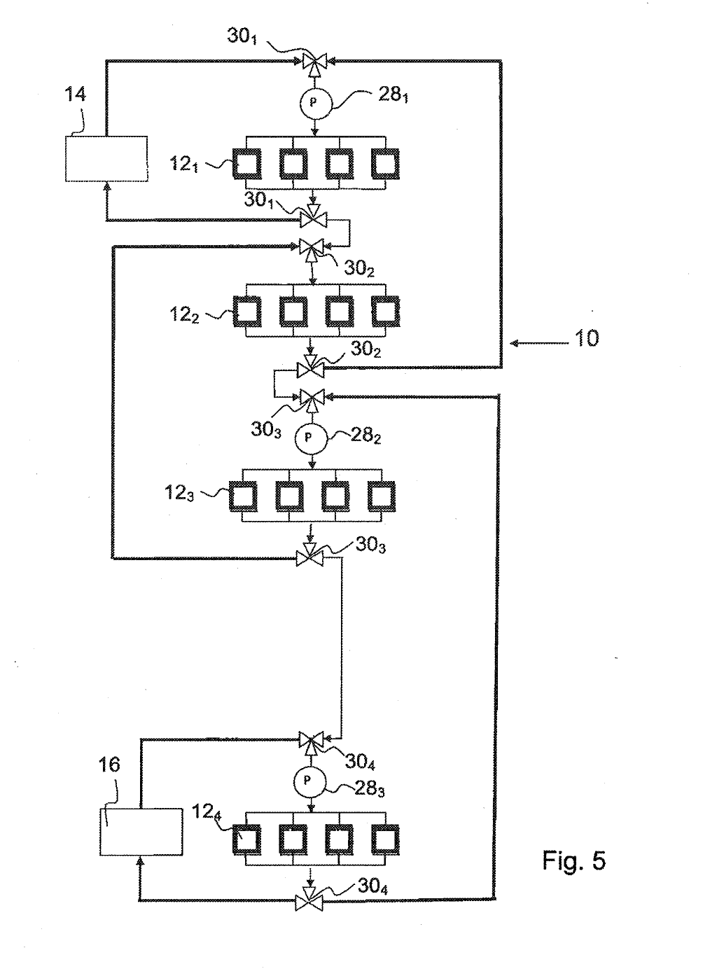

In FIG. 5 there is disclosed a schematic diagram of a fourth embodiment of an energy system 10 according to the present invention. In this embodiment, there are four groups with four energy cells each, i.e. 12₁;12₂;12₃ and 12₄. In this particular embodiment, there are three pump means 28₁-28₃, and eight valve means 30₁-30₄.

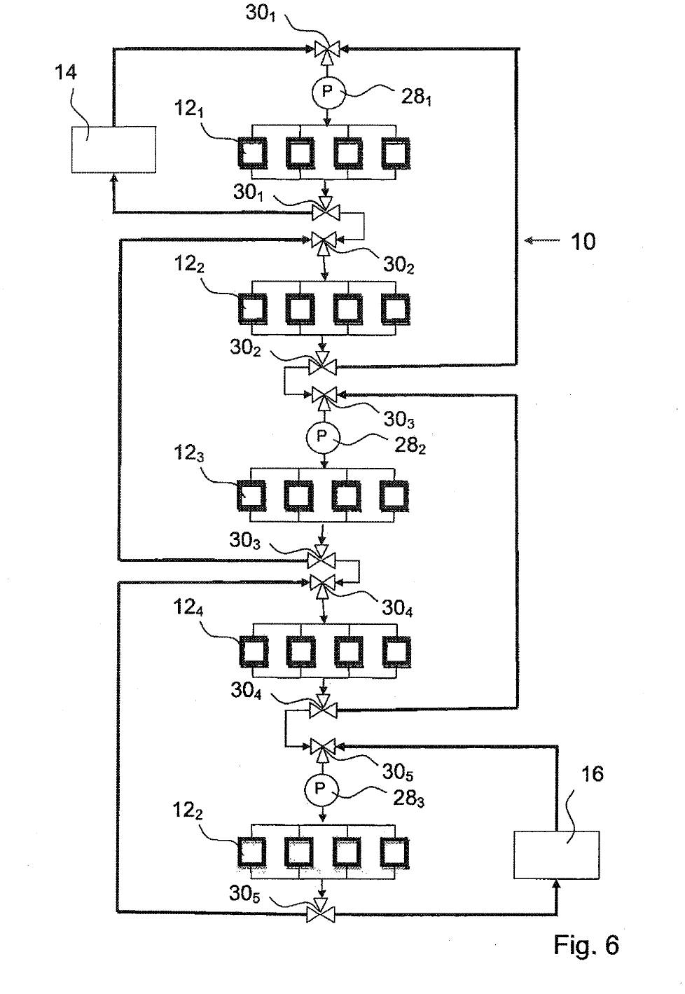

In FIG. 6 there is disclosed a schematic diagram of a fifth embodiment of an energy system 10 according to the present invention. In this embodiment, there are five groups with four energy cells each, i.e. 12₁;12₂;12₃; 12₄ and 12₅. In this particular embodiment, there are three pump means 28₁-28₃, and ten valve means 30₁-30₅.

In the embodiments disclosed in FIG. 3-6, there are so called minimal configuration regarding number of pump means, and number of valve means. The general principles applicable in the minimal configuration are Number of pump means=[n/₂]+1 and number of valve means=n×2, wherein n is the number of groups.

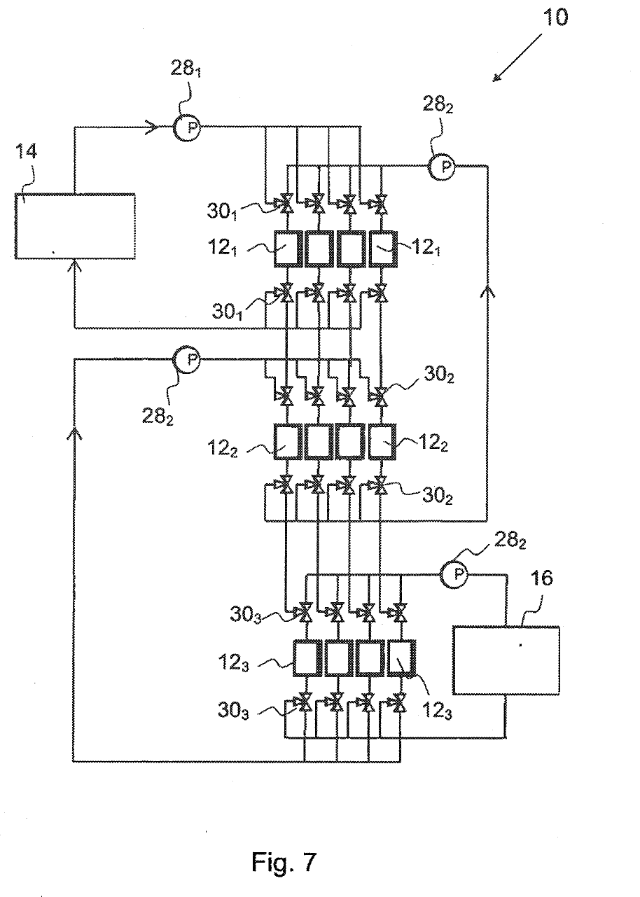

In FIG. 7 there is disclosed a schematic diagram of a sixth embodiment of an energy system 10 according to the present invention. In this embodiment, there are three groups with four energy cells each, i.e. 12₁;12₂ and 12₃. In this particular embodiment, there are four pump means 28₁ and 28₂, and 24 valve means 30₁-30₃.

In the embodiment disclosed in FIG. 7, there is so called maximal configuration regarding number of pump means, and number of valve means. The general principle applicable in the maximal configuration are. Number of pump means=n+1, and number of valve means=n×c×2, wherein n is the number of groups, and c is the number of cell in each group.

It is pointed out that the embodiments disclosed in FIG. 3-7, where there are four energy cells in each group, is just an example. The general case is n energy cells in each group, wherein n is an integer, and n≧1.

A disadvantage with the embodiment disclosed in FIG. 7 is that the number of valve means and pump means becomes large. On the other hand, an advantage with this embodiment is that the response time gets faster due to the fact that valve means are situated closer to the energy cell. This means that the amount of inactive “heat transfer media” gets smaller.

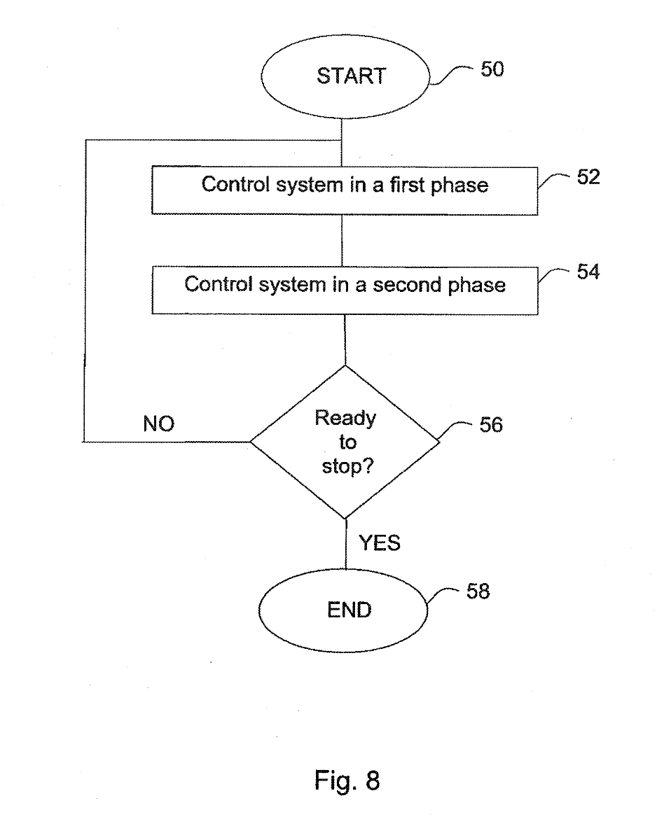

In FIG. 8 there is disclosed a flow chart of a method far regenerating heat energy according to the present invention. The method is performed with the aid of an energy system 10 (see e.g. FIG. 1-7) comprising n number of energy cells 12₁-12ₙ, wherein n is an integer, and n>2. The energy cells 12₁-12ₙ are connected in a sequence. Each energy cell 12₁, . . . ,12ₙ comprises a phase change material PCM₁-PCMₙ, with an average phase change temperature PCMT₁-PCMTₙ, wherein PCMT₁>PCMT₂>. . . >PCMTₙ. The energy cells 12₁-12ₙ performs the steps:

to produce mechanical energy, which also causes rest heat energy RH₁-RHₙ stored in the energy cells 12₁-12ₙ, when the phase change material PCM₁-PCMₙ change from solid phase to liquid phase,; or

to cool down when the phase material PCM₁-PCMₙ changes from liquid phase to solid phase;

to transfer the rest heat energy RHₓ from one energy cell 12ₓ which is cooling down as input energy to the next energy cell 12ₓ₊₁;

The method begins at block 50. Thereafter, the method continues, at block 52, with the step: with the aid of a control means 18 connected to the energy cells 12₁-12ₙ, to control the system 10 in a first phase, wherein every two energy cells 12₁,12₃,12₅, . . . procedures mechanical energy, and every two energy cells 12₂,12₄,12₆, . . . are cooling down. The method continues, at block 54, with the step:

with the aid of the control means 18, to control the system 10 in a second phase, wherein every two energy cells 12₂,12₄,12₆, . . . produces mechanical energy, and every two energy cells 12₁,12₃,12₅, . . . are cooling down. Thereafter, the method continues, at block 56, to answer the question: Ready to stop the method? If the answer is negative the method continues by performing the step at block 52 once again. If, on the other hand, the answer is affirmative, the method is completed at block 56.

According to a preferred embodiment of the method, it also comprises the steps:

with the aid of a heat source 14 connected to the first energy cell 12₁, to transfer heat energy to the first energy cell 12₁; or

with the aid of a cooler means 16 connected to the last energy cell 12ₙ, to remove the rest energy RHₙ from the last energy cell 12ₙ.

According to another embodiment of the method, it also comprises the step: with the aid of a heat transfer system 22 connected to the heat source 14, to the cooler means 16, and to each of the energy cells 12₁-12ₙ, to transfer heat energy between the heat source 14, the energy cells 12₁-12ₙ, and the cooler means 16.

According to a preferred embodiment of the method, it also comprises the step: for each phase change material PCM₁-PCMₙ, to perform the phase change between two different temperatures, Tₐ₁, and T_{b1}, Tₐₙ, and T_{bn}, wherein T_{b1}>Tₐ₁, and in that the average phase change temperature is defined as PCMT1=(Tₐ₁+T_{b1})/2.

According to another embodiment of the method, it also comprises the step: to choose the temperatures in such a way that Tₐ₁>Tₐ₂, T_{b1}>T_{b2}, . . . , T_{bn-1}>T_{bn}.

The invention is not limited to the embodiments described in the foregoing. It will be obvious that many different modifications are possible within the scope of the following claims.

1. An energy system operable to regenerate heat energy, said energy system comprises n number of energy cells wherein n is an integer, and n≧2, said energy cells are connected in a sequence, said system also comprises a heat source connected to said first energy cell, and a cooler means connected to said last energy cell, each energy cell comprises a phase change material (PCM₁, . . . ,PCMₙ) with an average phase change temperature (PCMT₁, . . . ,PCMTₙ), wherein PCMT₁>PCMT₂>, . . . ,>PCMTₙ, each energy cell either produces mechanical energy which also causes rest heat energy (RH₁, . . . ,RHₙ) stored in said energy cell when the phase change material (PCM₁, . . . ,PCMₙ) changes from solid phase to liquid phase or is cooling down when the phase change material (PCM₁, . . . ,PCMₙ) changes from liquid phase to solid phase, when the rest heat energy (RHx) from an energy cell (12ₓ) which is cooling down is transferred as input energy to the next energy cell said system also comprises a control means connected to said energy cells, and operable to control said system alternately between a first phase, and a second phase, wherein, during said first phase, a first every two energy cells, produces mechanical energy, and a second every two energy cells are cooling down, and vice versa during said second phase.

2. An energy system operable to regenerate heat energy according to claim 1, wherein each energy cell comprises a chamber means comprising said phase change material (PCM₁, . . . ,PCMₙ), and in that said system also comprises a heat transfer system connected to said heat source, and to said cooler means, and to each of said chamber means.

3. An energy system operable to regenerate heat energy according to claim 1, wherein said phase change for each phase change material (PCM₁, . . . ,PCMₙ) occurs between two different temperatures (Tₐ₁ and T_{b1}, . . . , Tₐₙ and T_{bn}), wherein T_{b1}>Tₐ₁, and in that said average phase change temperature is defined as PCMT₁=(Tₐ₁+T_{b1})/2.

4. An energy system operable to generate heat energy according to claim 3, wherein Tₐ₁>Tₐ₂, T_{b1}>T_{b2}, . . . , T_{bn-1}>T_{bn}.

5. An energy system operable to regenerate heat energy according to claim 2, wherein said heat transfer system comprises n number of container means, wherein each container means is connected to a chamber means, and in that said heat transfer means also comprises a first conduit means connected to said heat source, to the cooler means, and there in between to an upper part of each container means, and a second conduit means connected to said heat source, to the cooler means, and there in between to a lower part of each container means, and in that said heat transfer system is equipped with a heat transfer media.

6. An energy system operable to regenerate heat energy according to claim 5, wherein said heat transfer media is water, oil, heat pipes or other suitable media in liquid or gas phases.

7. An energy system operable to regenerate heat energy according to claim 1, wherein said energy system also comprises at least one valve means and/or at least one pump means, operable in connection with said alteration between said first phase and said second phase.

8. A method for regenerating heat energy with the aid of an energy system comprising n number of energy cells, wherein n is an integer, and n≧2, said energy cells are connected in a sequence, each energy cell comprises a phase change material (PCM₁, . . . ,PCMₙ) with an average phase change temperature (PCMT₁, . . . ,PCMTₙ) wherein PCMT₁>PCMT₂>, . . . ,>PCMTₙ, said energy cells performs the steps:
to produce mechanical energy, which also causes rest heat energy (RH₁, . . . ,RHₙ) stored in said energy cell when the phase change material (PCM₁, . . . ,PCMₙ) changes from solid phase to liquid phase; or
to cool down when the phase change material (PCM₁, . . . ,PCMₙ) changes from liquid phase to solid phase;
to transfer said rest heat energy (RHₓ) from one energy cell (12ₓ) which is cooling down as input energy to the next energy cell, said method comprises the step:
with the aid of a control means connected to said energy cells, to control said system alternately between a first phase, and a second phase, wherein, during said first phase, a first every two energy cells produces mechanical energy, and a second every two energy cells are cooling down, and vice versa during said second phase.

9. A method for regenerating heat energy according to claim 8, wherein said method also comprises the steps:
with the aid of a heat source connected to said first energy cell, to transfer heat energy to said first energy cell; or
with the aid of a cooler means connected to said last energy cell, to remove said rest heat energy (RHₙ) from said last energy cell.

10. A method for regenerating heat energy according to claim 9, wherein said method also comprises the step:
with the aid of a heat transfer system connected to said heat source, to said cooler means, and to each of said energy cells, to transfer heat energy between said heat source, said energy cells, and said cooler means.

11. A method for regenerating heat energy according to claim 8, wherein said method also comprises the step:
for each phase change material (PCM₁, . . . ,PCMₙ), to perform said phase change between two different temperatures (Tₐ₁ and T_{b1}, . . . ,Tₐₙ and T_{bn}), wherein T_{b1}>Tₐ₁, and in said average phase change temperature is defined as PCMT₁=(Tₐ₁+T_{b1})/2.

12. A method for regenerating heat energy according to claim 11, wherein said method also comprises the step:
to choose said temperatures in such a way that Tₐ₁>Tₐ₂, T_{b1}>T_{b2}, . . . ,T_{bn-1}>T_{bn}.
